(19) United States
(12) Patent Application Publication
(10) Pub. No.: US 2012/0098423 A1
(43) Pub. Date: Apr. 26, 2012

(54) MERCURY-FREE HIGH-INTENSITY GAS-DISCHARGE LAMP

(75) Inventors: Michael Haacke, Aachen (DE); Ulrich Hechtfischer, Aachen (DE); Hermann Giese, Roetgen (DE)

(73) Assignee: KONINKLIJKE PHILIPS ELECTRONICS N.V., EINDHOVEN (NL)

(21) Appl. No.: 13/318,790

(22) PCT Filed: May 4, 2010
(86) PCT No.: PCT/IB10/51939

§ 371 Date: Nov. 4, 2011

(30) Foreign Application Priority Data
May 7, 2009 (EP) 09159692.4

(51) Int. Cl. H01J 61/12; H01J 61/04; H01J 61/16

(52) U.S. Cl. 313/570; 313/637; 313/620

(57) ABSTRACT

The invention describes a mercury-free high-intensity gas-discharge lamp (1) comprising a discharge vessel (5) enclosing a filling in a discharge chamber (2) and comprising a pair of electrodes (3, 3′, 4, 4′) extending into the discharge chamber (2), for which lamp (1) the electrodes (3, 3′, 4, 4′) are free of thorium, and the filling includes a halide composition comprising at least 6 wt % thorium iodide.

### FIELD OF THE INVENTION

The invention describes a mercury-free high-intensity discharge lamp.

### BACKGROUND OF THE INVENTION

In a high-intensity discharge (HID) lamp, such as a xenon lamp for automotive applications, it is desirable to have a very high light output that is maintained over the lifetime of the lamp. The performance of a gas-discharge lamp depends to a large extent on the performance of its electrodes. Good electrode performance means that electrode losses are small, that the electrodes retain their shape, that little electrode material is evaporated, and that the electrodes do not interact negatively with the various chemical processes in the hot lamp. The lamp performance can also be influenced by the composition of the filling, which comprises an inert gas and a salt fill, usually introduced in the form of pellets which vapourize during operation. The salt fill can comprise a number of metal halides chosen according to their specific properties, for example a particular metal halide can be included for its contribution to the colour point of the lamp.

It is well known in the state of the art that the addition of an emitter material—normally a metal and often thorium—to the electrode material or to the lamp filling can improve electrode performance considerably. Such metals, when present even in small amounts on the electrode surface during operation, can lower the work function of the electrode and thus enable cathodic electron emission at lower electrode temperatures. A lower electrode temperature, in turn, usually results in an improved electrode performance.

The emitter material is usually added as a dopant in the form of an oxide, e.g. thorium oxide (ThO₂), to the bulk electrode material. When added in this way, the emitter material is referred to as a “solid-state emitter”, and the electrodes are referred to as “thoriated electrodes”. In some prior-art automotive lamps, the solid-state approach has been used to improve the electrode performance, since thorium oxide has been proven to have a beneficial influence on the electrodes, particularly during the critical run-up phase. The solid-state emitter is effective particularly during run-up since thorium is released quite readily by the electrodes as they heat. For automotive headlamps, the run-up is at a very high current, so that the electrodes heat very quickly, and the presence of the emitter is therefore most important during this phase in order to lower the work function. Without any measures to counteract this sudden and extreme heating of the electrodes, these are subject to extreme burn-back, and may in fact become brittle and break.

However, the disadvantage of the solid-state approach is that the oxygen contained in the thorium oxide has detrimental side-effects on the chemistry in the lamp, leading ultimately to a drop in light output (lumen) over the lifetime of the lamp. For example, thorium oxide (ThO₂) can evaporate from the electrodes and react with scandium iodide (ScI₃) in the fill gas to give thorium iodide (ThI₄), but also scandium oxide (Sc₂O₃). As a result, a proportion of the scandium is bound as an oxide and is no longer available in the gas phase, so that the lamp efficiency is poorer.

Another disadvantage is that, owing to manufacturing limitations, the thorium oxide is generally distributed throughout the bulk of the thoriated electrode, but only a fraction of the added amount is actually required, near the electrode tip. This waste of material is undesirable because thorium oxide is scarce. Furthermore, thorium is a radioactive material and is considered to have a negative environmental impact. A further disadvantage of adding thorium to the bulk of the electrodes is that, over time, the thorium will react with the molybdenum foil connecting the thoriated electrodes to the lead wires outside the lamp, leading to failure of the lamp caused by pinch cracks.

Some attempts have been made to include thorium as a “gas-phase emitter”, by including a thorium halide as part of the salt fill, which is initially present in the discharge chamber of the lamp as a solid (as salt pellets), and which must first vapourize before the thorium is available in a gaseous form to cover the electrode. For example, the mercury-based HID lamp described in U.S. Pat. No. 4,798,995 combines conventionally thoriated tungsten electrodes with a small amount of thorium iodide in the lamp filling, so that a thorium/halide transport cycle can be established in which thorium evaporated from the thorium oxide at the electrode tips is returned by the thorium halide. U.S. Pat. No. 6,809,478 B2 also describes a lamp with electrodes doped with thorium oxide, and a filling containing a small amount of thorium iodide. In both of these documents, the inability of the thorium iodide to act on its own to effectively lower the work function of the electrodes during run up must be compensated by using sufficient thorium oxide in the electrodes.

The commonly accepted belief was that a gas-phase emitter can only become effective after the salt fill has sufficiently vapourized, a procedure which takes a certain amount of time. As long as the vapourization is insufficient, the emitter material cannot act to lower the electrode work function. For an HID lamp of the type described herein, up to 20 seconds of time may easily elapse before the salt fill is sufficiently vapourized. This long time duration has generally been regarded as unacceptable. A lack of a reliable emitter leads to excessive electrode heating, stronger burn-back, and ultimately worsens electrode performance, possibly resulting in electrode failure. Evidently, such negative characteristics are unacceptable in a product such as an automotive headlight in which reliability is of paramount importance. For these reasons, a solid-state emitter has been the method of choice in prior-art gas discharge lamps, and any small amounts of thorium halide are usually only included in the salt fill for a specific influence on the colour point of the lamp. For example, in U.S. Pat. No. 6,376,988 B1, thorium in the fill gas has only been used for improved colour discernment. In fact, the use of thorium iodide was in some approaches completely rejected and other techniques for improving electrode performance were adopted. WO 2007/026288, for example, describes a lamp that is entirely free of thorium, but the electrode performance of the lamp described does not compare favourably with a lamp using thorium as a solid-state emitter.

A known problem associated with HID lamps that use xenon as a buffer gas is that electromagnetic interference (EMI) can arise during the run-up phase after ignition and in steady-state operation. The lamp then generates a radio-frequency signal that can have a negative effect on the electronics in the car, for example on-board TV receivers.

The occurrence of EMI is much less likely when the lamp is operating in its stable ‘spot mode’. For this reason, once the lamp is ignited, it is desirable for the lamp to switch from the diffuse mode to spot mode as early as possible. Adding thorium iodide as a gas-phase emitter helps, but in prior-art lamps the spot did not appear early enough, owing to an initially insufficient presence of thorium in the gas phase, since the salt pool must first reach a certain temperature before sufficient thorium is available.

Mercury was initially included in the fill gas of HID lamps for a number of reasons, for example, it is a very efficient radiator, giving a favourable light output at a relatively low operating temperature. Mercury also has a high vapour pressure, so that a high lamp voltage can be obtained with a resulting low operating current. In spite of these advantages, moves have been made in recent years to eliminate mercury from certain types of automotive lamps for environmental and health reasons, and lamp standards have been developed accordingly. However, the omission of mercury exacerbates the above-mentioned problems.

Therefore, it is an object of the invention to provide a mercury-free high intensity discharge lamp that avoids the problems mentioned above.

### SUMMARY OF THE INVENTION

The object of the invention is achieved by the mercury-free high-intensity gas-discharge lamp according to claim 1.

According to the invention, the mercury-free high intensity gas-discharge lamp comprises a discharge vessel enclosing a filling in a discharge chamber and comprising a pair of electrodes extending into the discharge chamber, for which lamp the electrodes are free of thorium, and the filling includes a halide composition comprising at least 6 wt % thorium iodide. The “halide composition”, also usually referred to as the “salt fill” is generally added to the filling in the form of salt pellets, and the terms “salt fill” and “halide composition” may therefore be used interchangeably. During operation of the lamp, when the discharge chamber is heated, the filling largely evaporates, and may therefore be referred to as a “fill gas”. In the following, the terms “filling” and “fill gas” may therefore be used interchangeably.

The expression “free of thorium” as applied to an electrode is to be understood to mean that the electrode is manufactured without including any thorium oxide. Such an electrode can also be referred to as a “non-thoriated” electrode. Since electrodes for high-intensity discharge lamps are generally made of tungsten, it may be assumed in the following that the bulk material of the non-thoriated electrodes in a lamp according to the invention comprises primarily tungsten.

Experiments with the lamp according to the invention have shown that, by adding the emitter metal as a gas-phase emitter in the form of a salt—e.g. thorium iodide ThI₄—to the salt fill of the mercury-free lamp in such high concentrations, the electrode performance was comparable to that obtained by prior-art lamps using a solid-state emitter approach. The experiments considered relevant performance requirements such as “time-to-spot”, “lumen maintenance” (these terms will be explained below), and the near-cathode plasma brightness during the early run-up, observed in successive burnings of the lamp. A high level of near-cathode plasma brightness during early run-up (in the first ten seconds or so) is a reliable indicator that the lamp's emitter is functioning satisfactorily, and that the electrodes of the lamp are sufficiently ‘cool’. In experiments with the lamp according to the invention, without any solid-state emitter, unexpectedly high plasma brightness levels were observed. These observations were very surprising, since the accepted understanding has long been that any emitter included as part of the salt fill would simply be unavailable for the time it takes for the salt fill to sufficiently evaporate or vapourize. The explanation for these unexpected positive observations is that, during burn-in, sufficient quantities of the salt fill evaporate and dissociate, so that a quantity of thorium is deposited on the electrode surface and migrates into the body of the electrode. The migrated thorium remains in the electrode when the lamp is turned off. In a subsequent run-up phase, the thorium is to some extent still present in the electrodes, and only a part of it is bound as thorium iodide in the salt fill. Therefore, once the burn-in procedure has been carried out for a lamp, a part of the thorium is available as a solid-state emitter immediately after turning on the lamp and therefore immediately acts to lower the electrode temperature, even before any thorium has evaporated from the salt fill.

In other words, the thorium emitter behaves as if it had originated from the electrode bulk material, so that the lamp according to the invention combines the advantages of using thorium iodide as a gas-phase emitter with the advantages of using thorium as a solid-state emitter but without the attendant disadvantages, since thorium oxide is not required; the negative side-effects of oxygen in the lamp are avoided; the total amount of thorium in the lamp is much lower than in prior-art lamps using thoriated electrodes (by one to two orders of magnitude); and the lifetime of a lamp is longer compared with prior-art lamps using thoriated electrodes. Another advantage of the lamp according to the invention is that, since the electrodes initially do not contain any thorium, the molybdenum foil (also referred to as “Mo-foil”) remains unaffected for a considerable length of time by any thorium originating from the electrodes, thus prolonging the lifetime of the lamp.

Prior-art mercury-free automotive headlamps with non-thoriated electrodes and having thorium iodide in the fill gas such as those mentioned in the introduction generally only have a low percentage of thorium iodide, e.g. two weight percent (2 wt %) or less, usually included to influence the colour point. These lamps are characterized by a severe drop in light flux from 200-400 lm after 15 hours, corresponding to about 10% of initial lumen output. The drop in light output is so severe that such lamps fail to satisfy customer specifications. Furthermore, the gas-phase concentration of thorium iodide in the fill gas of such prior-art lamps is initially too low so that the performance during the run-up phase is not satisfactory. However, in the mercury-free lamp according to the invention, the increased level of thorium iodide in conjunction with the non-thoriated electrodes was shown to result in a lamp with a relatively steady light out-put, i.e. its lumen loss during ageing from 45 min to 15 hrs was advantageously lower than in comparable prior-art lamps. In other words, the lumen output of the lamp embodiments according to the invention is more stable.

Furthermore, experiments with embodiments of the lamp according to the invention have shown that a surprisingly good electrode performance, comparable to prior-art mercury-free lamps with thoriated electrodes, can be achieved. These experiments also showed a significant improvement in the EMI behaviour of the lamp during run-up. Furthermore, experiments with the lamp according to the invention have shown that the relatively high concentration of thorium iodide in the salt fill allows the thorium to already take effect during the early run-up phase of the lamps, a property which, until now, was obtainable only with a solid-state emitter.

In a simple and economic solution, therefore, the lamp according to the invention enjoys favourable electrode performance, similar to lamps that employ thorium as a solid-state emitter, while being more long-lived (since less scandium is bound as an oxide, and the molybdenum foil is less prone to damage) and more environmentally friendly (since the overall amount of thorium used in the lamp is lower) than prior-art lamps using thorium as a solid-state emitter.

The dependent claims and the subsequent description disclose particularly advantageous embodiments and features of the invention.

The lamp according to the invention can be used in place of prior-art D1-D4 headlamps. Since the lamp according to the invention is mercury-free, it may be referred to in the following as a D3 or D4 lamp, without however restricting the invention in any way. Furthermore, any reference to a metal halide by chemical formula, for example ThI₄ for thorium iodide, does not preclude the use of another metal salt of that metal and halogen. For example, in the lamp according to the invention, the thorium halide could be any of thorium bromide, thorium chloride or thorium fluoride.

The weight of the total salt fill in the filling of the lamp according to the invention is preferably at least 100 μg and at most 400 μg. More preferably, the weight of the total salt fill is at least 250 μg and at most 350 μg, suitable for a D3 or D4 lamp.

The lumen output and the colour point of a mercury-free HID lamp are governed by many factors, such as salt-fill composition, dimensions of the discharge chamber, size and position of the electrodes, etc. Furthermore, the physical construction of the lamp, the conditions under which it is operated, and the pressure of the fill gas in the lamp all serve to influence its light output. The fill gas of a HID lamp generally includes a number of important substances, each of which is chosen to fulfil a certain requirement. For example, the combined amount of sodium iodide and scandium iodide in the fill gas determines the efficiency of the lamp. Evidently, the relative proportions of these metal salts can be adjusted as required, and the relative amounts can be adjusted to control variations in lumen output, position of the colour point relative to the black-body line, etc. Therefore, the lamp according to the invention preferably comprises a fill gas with a halide composition comprising at least 35 wt % and at most 60 wt % of sodium iodide, and comprising at least 20 wt % and at most 40 wt % of scandium iodide. To further improve the performance of the lamp according to the invention, the halide composition of the fill gas more preferably comprises sodium iodide to a proportion of at least 20 wt % and at most 40 wt %, and scandium iodide to a proportion of at least 25 wt % and at most 35 wt %. These levels of sodium iodide and scandium iodide ensure that the lamp provides a sufficiently high light output.

As already mentioned above, HID lamps using mercury and having thoriated electrodes can produce a favourable white light. The colour point of such lamps is further refined by including compounds of certain elements such as cesium, thallium, thorium, etc. However, without mercury, the sodium iodide and scandium iodide tend to produce a light with a yellowish tinge, which is undesirable for automotive applications, since a yellowish colour impairs the ability of a driver to discern colours of objects illuminated by the headlamps. For this reason, mercury-free HID lamps generally include certain amounts of other substances or compounds in the fill gas in order to provide a colour temperature in the required range. Therefore, in a further preferred embodiment of the invention, the fill gas of the mercury-free HID lamp includes a halide composition comprising at most 20 wt % zinc iodide and comprising at most 0.5 wt % of indium iodide.

Automotive HID lamps usually contain a proportion of xenon gas in order to accelerate the run-up time and to provide an acceptable light output directly after ignition. Therefore, the fill gas in the lamp according to the invention preferably comprises xenon gas under a pressure of at least 12 bar in a non-operational state. This is referred to as the ‘cold pressure’ of the lamp.

The behaviour or performance of a high-pressure gas discharge lamp such as an automotive HID lamp will change over time. During the first 45 minutes of operation, the so-called “burn-in” time, very favourable results may be observed, after which the results may decline. The first fifteen hours of operation of a lamp of this type is therefore regarded as the ‘ageing’ time. After the ageing time, relevant values such as lumen output, efficiency etc., may be assumed to have reached their settled values. As will be described below, the mercury-free lamp according to the invention, using the indicated high concentrations of thorium iodide to provide a gas-phase emitter, achieved a very favourable performance after ageing compared to prior-art lamps.

The electrodes of an HID lamp are usually arranged so that they protrude into opposite ends of the discharge chamber. Because of the distorting refractive properties of the quartz glass of the discharge vessel, the actual separation of the electrodes generally cannot be optically determined, and is usually carried out using, for example, an X-ray technique. For this reason, the electrode separation is generally expressed as an ‘optical separation’. In the lamp according to the invention, the electrodes are positioned in the discharge chamber such that the electrode tips comprise an optical separation of at least 3.8 mm and at most 4.6 mm. A ‘real’ separation of 3.7 mm, for example, corresponds to an optical separation of about 4.2 mm. Generally, the dimensions and thickness of the electrodes in an HID lamp also have an effect on the performance of the lamp. The maintenance of a stable arc depends to a large extent on the geometry of the electrodes, in particular their diameter, since the thickness of the electrodes governs the electrode temperature that is reached during operation, which in turn determines the commutation behaviour and the burn-back of the electrodes according to the ballast parameters. An electrode can be realised as a simple rod shape of uniform diameter from tip to pinch, or can be realised to be wider at the tip that at the pinch, or to be narrower at the tip than at the pinch, for example an electrode might feature a small ‘nose’ directed outward from its tip or front face. Evidently, the dimensions given in the following apply to the initial dimensions of the electrodes before burning.

For some concentrations of thorium iodide, the lamp embodiments according to the invention have shown that ‘thin’ electrodes yield a satisfactory performance. In a lamp according to the invention, therefore, the greatest diameter in the front region of an electrode is preferably at least 200 μm and at most 400 μm. More preferably, the electrode diameter is between 260 μm and 360 μm. Stepped electrodes may also be used in a lamp according to the invention, in which case the diameter at the tip may be between 360 μm and 400 μm, while the diameter of the electrode shaft is narrower towards the pinch. For example, good results were obtained with 8.3 wt % thorium iodide and 300 μm electrodes (lumen loss after ageing was only about 100 lm). However, using such concentrations of thorium iodide with ‘thin’ electrodes, undesirable EMI levels may arise. Therefore, in a preferred embodiment of the invention, the diameter at the tip of the electrode is preferably approximately 360 μm, for example at least 300 μm and at most 400 μm. Observations carried out on a lamp according to the invention with 8.3 wt % thorium iodide and 360 μm showed no decrease in light after ageing. Furthermore, with these parameters, the EMI performance of the lamp was noticeably improved.

An important consideration for an automotive HID lamp is the time it takes for the lamp to reach ‘spot’ mode, i.e. the time after ignition that elapses until the discharge arc develops from an initial diffuse mode to a final spot mode. This time is usually referred to as the ‘time-to-spot’, and should ideally be as short as possible. Prior-art D3 and D4 lamps can achieve a favourable time-to-spot, but only at the cost of using thoriated electrodes with the disadvantages mentioned already in the introduction. Experiments with the lamp according to the invention have shown that the higher concentration of thorium iodide in the salt fill has a positive influence on the time-to-spot. For example, a lamp with about 17 wt % ThI₄ content and thin electrodes (approx. 300 μm) exhibited a low time-to-spot of only 7 seconds after ageing, comparable to results obtainable using prior-art lamps with thoriated electrodes. Using thick electrodes (approx. 360 μm), the time-to-spot was reduced even further to about 1 second after ageing for a lamp with 17 wt % ThI₄. However, the lamp according to the invention can also achieve a favourable time-to-spot of about 1 second with lower levels of thorium iodide, for example a proportion of only 8.5 wt %, in combination with thicker electrodes (approx. 360 μm). Due to these brief time-to-spot durations, EMI behaviour during run-up was observed to be significantly reduced in lamp embodiments according to the invention.

Another important characteristic of an HID lamp is its “lumen maintenance”, i.e. the stability of the luminous flux output by that lamp over its lifetime. For example, a prior-art D4 lamp with 2 wt % ThI₄ in a total salt amount of 300 μg can exhibit a drop in light flux of 200-400 lm after ageing, which may be about 10% of initial lumen output. Such a high drop in lumen is too severe, so that this lamp would fail to satisfy costumer specifications. Therefore, a goal during development of a lamp series is a lamp that exhibits favourable characteristics for the first 45 minutes of burn-in and whose characteristics have not changed noticeably after 15 hours of ageing.

In experiments with embodiments of the lamp according to the invention, it has been observed that the relatively high thorium iodide content has a significant positive influence on the lumen loss during ageing. Experiments with the lamp according to the invention have shown that a thorium iodide content of around 8.5 wt % or more limits the drop in lumen output to around 0-100 lm. Therefore, in a further preferred embodiment of the invention, the proportion of thorium iodide in the halide composition comprises at least 7 wt %, preferably at least 8 wt %, more preferably at least 9 wt %, and most preferably at least 10 wt %.

Experiments with the lamp according to the invention with a relatively high concentration of thorium iodide in the region of 8-18 wt % showed that the overall obtainable lumen output was stable. However, further experimentation showed that the lumen output could be increased by adjusting other factors. For example, the initial cold pressure of the lamp can be increased. Therefore, in a further preferred embodiment of the invention, the fill gas comprises xenon gas under a pressure of at least 14 bar in a non-operational state. Light flux can also be positively influenced by adjusting the levels of zinc iodide in the lamp. Therefore, in a further preferred embodiment of the invention, the fill gas includes a halide composition comprising a reduced zinc iodide concentration of at most 5 wt %. The relative proportions of sodium iodide and scandium iodide can also have a positive influence on the light flux of the lamp, so that, in a preferred embodiment of the lamp according to the invention, the fill gas includes a halide composition comprising sodium iodide and scandium iodide such that the ratio (by weight) of sodium iodide to scandium iodide approaches but does not drop below 1.0.

As indicated above, a known problem with HID lamps is that some thorium will ultimately arrive at the molybdenum foil and may result in damage to the foil and cracks in the pinch area. Therefore, in a further preferred embodiment of the lamp according to the invention, the molybdenum foil is located further back in the pinch area, i.e. at a greater distance from the discharge chamber, so that the point at which an electrode is connected to the molybdenum foil is also located further back in the pinch area. The additional distance can comprise about 2 mm, so that the separation between the molybdenum foils in the two opposing pinch areas is increased. Preferably, an electrode is connected to the molybdenum foil positioned in the pinch region of the lamp such that an embedded length of the electrode between the edge of the molybdenum foil and an inner wall of the discharge chamber comprises a distance of at least 4 mm. The “embedded length” is to be understood to mean the length of the electrode embedded in the pinch area from the point at which the electrode protrudes from the inner wall of the discharge chamber into the pinch area, and up to the edge of the molybdenum foil to which it is connected. In effect, the molybdenum foil is moved away from the discharge vessel, and this increased distance means that the thorium takes considerably longer to arrive at the molybdenum foil, thus avoiding or at least postponing the problem by prolonging the time taken for this migration.

A longer electrode length in the pinch area can lead to another type of crack, namely a radial extended crack (REC), which can arise when the embedding length of the electrode is increased, as will be known to the skilled person. However, this can be avoided by using an alternative electrode shape. Therefore, in a further preferred embodiment of the lamp according to the invention, to further prolong the lifetime of a lamp having a high concentration of thorium iodide in the fill gas and electrodes that extend further into the pinch, alternative electrode shape could be used, for example a coiled electrode or a laser-structured (“hairbrush”) electrode, whose shape can lessen the likelihood of cracks in the pinch area that might develop because of an extended electrode length.

By appropriate combination of the features mentioned herein, the lamp according to the invention enjoys a number of advantages over comparable prior-art lamps. Compared to prior-art lamps with thorium-free electrodes, these advantages are:
Colder electrodes during early run-up;
short time-to-spot;
less electrode deformation over the lifetime of the lamp;
lower lumen loss during ageing.

Compared to prior-art lamps with thoriated electrodes, the advantages are:
no oxygen is introduced in the lamp so that the loss of scandium is minimized.
the molybdenum foil remains isolated from any propagated thorium for a longer time;
the total quantity of thorium in the lamp is lower than in a prior-art lamp with thoriated electrodes;
thorium iodide is more readily available than tungsten doped with thorium oxide.

Other objects and features of the present invention will become apparent from the following detailed descriptions considered in conjunction with the accompanying drawings. It is to be understood, however, that the drawings are designed solely for the purposes of illustration and not as a definition of the limits of the invention.

### BRIEF DESCRIPTION OF THE DRAWINGS

FIG. 1a shows a cross section of a gas-discharge lamp according to a first embodiment of the invention;

FIG. 1b shows a cross section of a gas-discharge lamp according to a second embodiment of the invention;

FIG. 2 shows a box plot of “time-to-spot” for a prior-art lamp and a number of lamps according to the invention;

FIG. 3 shows a box plot of light flux for a prior-art lamp and a lamp according to the invention;

FIG. 4 shows a graph of near-cathode plasma brightness measurements for a number of lamps according to the invention, having different thorium iodide concentrations in the filling, and for a prior art lamp.

In the drawings, like numbers refer to like objects throughout. Objects in the diagrams are not necessarily drawn to scale.

### DETAILED DESCRIPTION OF THE EMBODIMENTS

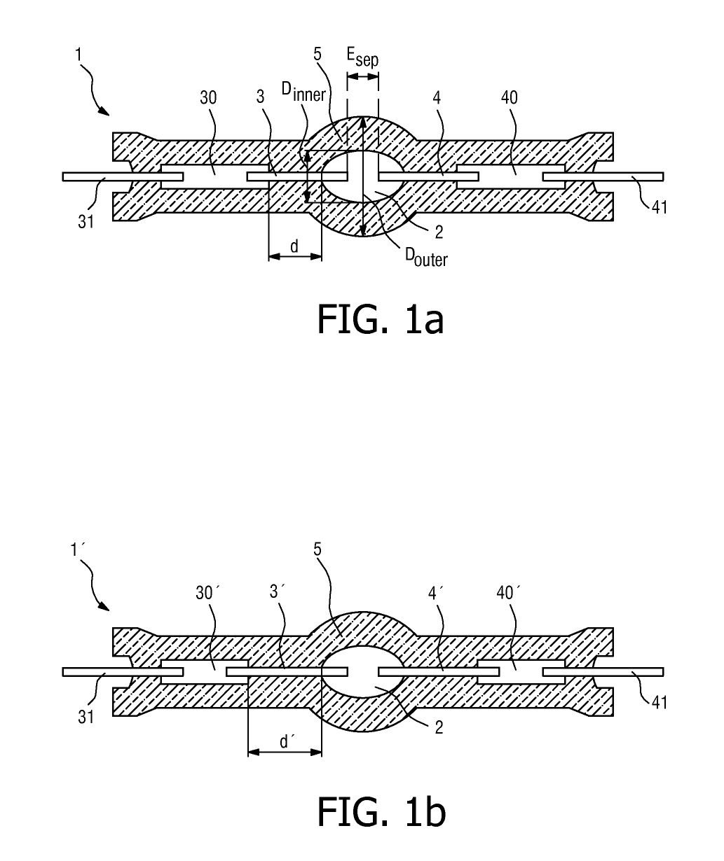

In FIG. 1, a cross section of a mercury-free quartz glass HID lamp 1 is shown according to an embodiment of the invention. Essentially, the lamp 1 comprises a quartz glass discharge vessel 5 enclosing a discharge chamber 2 containing a fill gas. The inner diameter Dᵢₙₙₑᵣ of the discharge chamber 2 shown in this example can be between 2.2 mm and 2.6 mm, and the outer diameter Dₒᵤₜₑᵣ can be between 5.3 mm and 6.3 mm, so that the capacity of the discharge chamber 2 can be between 15 μl and 30 μl. Two electrodes 3, 4 protrude into the discharge chamber 2 from opposite ends of the lamp 1. During manufacturing, the quartz glass of the discharge vessel 5 is pinched on both sides around the shafts of the electrodes 3, 4 to seal the fill gas in the discharge chamber 2. A connection between the electrodes 3, 4 and conductive leads 31, 41 to the outside is made by a molybdenum foil 30, 40 enclosed in the pinch or seal area. The electrodes 3, 4 therefore extend a certain distance into the pinch, as indicated for the electrode 3, which has an embedded length d in the pinch area, between the leading edge of the molybdenum foil 30 and the inner wall of the discharge chamber 2.

The electrodes 3, 4 are tungsten rods, manufactured to have been initially essentially free of thorium, and protrude into the discharge chamber 2 and are optically separated from each other by a certain distance, for example a distance governed by the relevant regulation for that lamp type. The ‘real’ electrode separation Eₛₑₚ for the lamp 1 shown in the example can be about 3.7 mm, corresponding to an optical separation of about 4.2 mm, satisfying D3 and D4 specifications. The electrodes 3, 4 of the lamp 1 according to the invention can be realised as simple rods of uniform thickness from base to tip. However, the thickness of the electrodes 3, 4 can equally well vary over different stages of the electrodes, so that, for example, an electrode 3, 4 is thicker at its tip and narrower at the base. In the embodiment described in the diagram, the electrodes 3, 4 can have a diameter of up to 360 μm (thick electrodes) or a diameter of up to 300 μm (thin electrodes). These values of diameter refer to the initial value before burning in each case.

For the sake of clarity, the diagram shows only the parts that are pertinent to the invention. Not shown is the base and the ballast that is required by the lamp for control of the current or power of the lamp. Since these and other additional components will be known to a person skilled in the art, they will not be explained in any detail here. When the lamp 1 is switched on, the ballast's igniter rapidly pulses an ignition voltage at several thousand volts across the electrodes 3, 4 to initiate a discharge arc. The temperature in the discharge chamber increases rapidly, and the metal salts evaporate. While the arc of high luminous intensity is gradually established, the ballast regulates the power down to the operational level (for example 35W for a D4 lamp).

As already explained, a higher concentration of thorium iodide in the lamp's salt fill could ultimately lead to unwanted degeneration caused by pinch cracks in the seal area of the lamp. FIG. 1b shows a second embodiment of the lamp 1′ according to the invention, in which the shafts of the electrodes 3′, 4′ are longer than in the lamp 1 of FIG. 1a. The other dimensions may be taken to be the same as those of FIG. 1a. This allows the molybdenum foil 30′, 40′ to be enclosed in the pinch with a longer embedded length d′ of the electrode between a leading edge of the molybdenum foil 30′ and the inner wall of the discharge chamber 2. The increased embedded length results in a reduction of the temperature in that region and a reduction in the likelihood of thorium reaching the molybdenum foil 30′, 40′. In this way, the lifetime of the lamp 1′ can be prolonged.

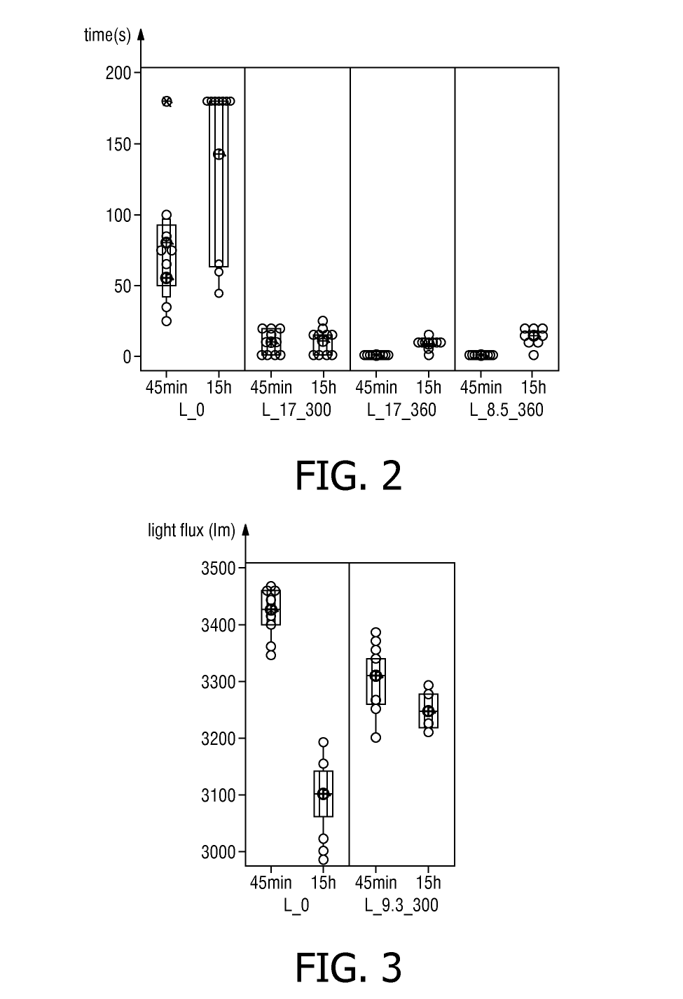

FIG. 2 shows a box plot of the time-to-spot measured for a prior-art lamp L_0 without any thorium iodide in the fill gas, and three lamps L_17_300, L_17_360, L_8.5_360 having thorium-free electrodes and high concentrations of thorium iodide in the fill gas.

The box plot shows the time elapsed until the discharge arc attaches to the electrodes in a small bright spot, as explained above. The prior-art lamp L_0 without any thorium iodide in the fill gas requires on average 103 s after the start to reach spot mode (after a burning-in time of 45 min). As these lamps age, the time-to-spot increases significantly, to an average of about 180 s, i.e. three minutes elapse before such a lamp reaches spot mode.

The lamp embodiments L_17_300, L_17_360, L_8.5_360 according to the invention deliver significantly better results. The lamp L_17_300 having 17 wt % thorium iodide and electrodes with a thickness of 300 μm reaches spot mode on average after approximately only 7 s after a burning-in time of 45 min, and after approximately 10 s after 15 hours of burning, respectively. The lamp L_17_360 with 17 wt % thorium iodide and electrodes with a thickness of 360 μm reaches spot mode on average after approximately 1 s after 45 mins of burning and after approximately 10 s after 15 hours of burning, respectively. The lamp L_8.5_360 having 8.5 wt % thorium iodide and electrodes with a thickness of 360 μm reaches spot mode on average after approximately 23 s after 45 mins of burning and after approximately 14 s after 15 hours of burning, respectively. These observed values indicate a significant improvement in time-to-spot using mercury-free lamps according to the invention with non-thoriated electrodes and higher thorium iodide concentrations. In particular the short time-to-spot for older lamps is a strong argument in favour of the lamp according to the invention, since automotive headlamps should reach spot mode in as short a time as possible.

The light flux delivered by the lamps according to the invention is also improved compared to the prior-art lamps. FIG. 3 shows a box plot of light flux in lumen (lm) for a prior-art lamp L_0 with no thorium iodide in the fill gas, and a lamp L_9.3_300 with 9.3 wt % thorium iodide and 300 μm electrodes. While the prior-art lamp L_0 delivers on average 3420 lm in the first 45 mins of burning (burn-in), the light flux drops considerably over time so that, after 15 hours of burning (ageing), these lamps only achieve on average 3100 lm. In contrast, the lamp L_9.3_{—}300 according to an embodiment of the invention delivers on average 3325 lm in the first 45 mins of burning, and 3250 lm after 15 hours. Clearly, the lumen loss for the prior-art lamp L_0 is noticeably worse than for the lamp L_9.3_300 according to the invention, which effectively maintains its high level of light flux. These experiments show that the higher levels of thorium iodide yield the most favourable results, allowing the use of thinner electrodes while achieving performance comparable to prior-art lamps with thoriated electrodes.

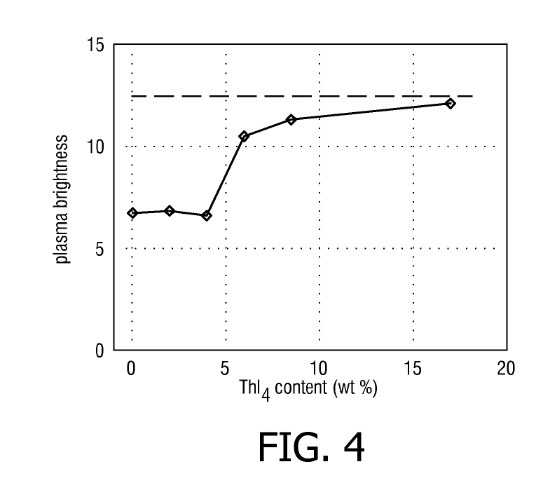

The marked improvement in plasma brightness in early run-up, obtainable using a lamp according to the invention, is illustrated with the aid of FIG. 4, which is a graph of near-cathode plasma brightness (averaged over early run-up from 0-10 s, and given in arbitrary units) against thorium iodide concentration for a number of lamps according to the invention having thorium-free 300 μm electrodes. For comparison, the plasma brightness obtainable by a prior art lamp with thoriated electrodes is given by the dashed line. As the concentration of thorium iodide is increased above about 5 wt %, the near-cathode plasma brightness in early run-up increases markedly. Values of between 6 wt % and 8 wt % deliver near-cathode plasma brightness levels that compare favourably with the prior art lamp. As mentioned in the introduction, a high near-cathode plasma brightness level in this early run-up phase is a reliable indicator that the lamp's emitter is functioning satisfactorily. As the graph shows, concentrations of thorium iodide in the region about 8 wt % and above deliver results that easily compare with the prior art lamp with thoriated electrodes, even though far less thorium is used overall.

Although the present invention has been disclosed in the form of preferred embodiments and variations thereon, it will be understood that numerous additional modifications and variations could be made thereto without departing from the scope of the invention.

For the sake of clarity, it is also to be understood that the use of “a” or “an” throughout this application does not exclude a plurality, and “comprising” does not exclude other steps or elements.

1. A mercury-free high intensity gas-discharge lamp comprising a discharge vessel enclosing a filling in a discharge chamber and comprising a pair of electrodes extending into the discharge chamber, for which lamp
the electrodes are free of thorium, and
the filling includes a halide composition comprising at least 6 wt % thorium iodide.

2. A lamp according claim 1, wherein the filling includes a halide composition comprising at least 35 wt % and at most 60 wt % sodium iodide and comprising at least 20 wt % and at most 40 wt % of scandium iodide.

3. A lamp according claim 1, wherein the filling includes a halide composition comprising at most 20 wt % zinc iodide and comprising at most 0.5 wt % of indium iodide.

4. A lamp according to claim 1, wherein the filling comprises xenon gas under a pressure of at least 12 bar in a non-operational state.

5. A lamp according to claim 1, wherein the electrodes are arranged at opposing ends of the discharge chamber and wherein the greatest diameter in the front region of an electrode is at least 200 μm and at most 400 μm.

6. A lamp according to claim 1, wherein the proportion of thorium iodide in the halide composition comprises at least 7 wt and at most 10 wt %.

7. A lamp according to claim 1, wherein the proportion of thorium iodide in the halide composition comprises at most 17.5 wt %.

8. A lamp according to claim 7, wherein the filling comprises xenon gas under a pressure of at least 14 bar in a non-operational state.

9. A lamp according to claim 7, wherein the filling includes a halide composition comprising at most 20 wt % zinc iodide.

10. A lamp according to claim 7, wherein the filling includes a halide composition comprising sodium iodide and scandium iodide such that the ratio of sodium iodide to scandium iodide approaches but does not drop below a value of 1.0.

11. A lamp according to claim 7, wherein an electrode is connected to a molybdenum foil positioned in a pinch region of the lamp such that an embedded length (d′) of the electrode between an edge of the molybdenum foil and an inner wall of the discharge chamber comprises a distance of at least 4 mm.

12. A lamp according to claim 7, wherein the electrodes comprise laser-structured electrodes.

13. A lamp according to claim 1 with a nominal power of between 20W and 35W,
wherein the capacity of the discharge chamber is greater than or equal to 15 μl and less than or equal to 30 μl.

14. A lamp according to claim 1, wherein the tips of the electrodes comprise an optical separation of at least 3.8 mm and at most 4.6 mm.

15. A lamp according to claim 7, wherein the electrodes comprise coiled electrodes.

16. A lamp according to claim 1 with a nominal power of between 20W and 35W, wherein the inner diameter (Dᵢₙₙₑᵣ) of the discharge chamber comprises at least 2.0 mm and at most 2.6 mm.

17. A lamp according to claim 1 with a nominal power of between 20W and 35W, wherein the outer diameter (Dₒᵤₜₑᵣ) of the discharge chamber is at least 5.3 mm and at most 6.3 mm.

18. A lamp according to claim 1 with a nominal power of between 20W and 35W, wherein the halide composition in the filling of the lamp has a combined weight of at least 100 μg and at most 400 μg.
